(19) United States
(12) Patent Application Publication
(10) Pub. No.: US 2016/0078489 A1
(43) Pub. Date: Mar. 17, 2016

(54) Systems and Methods of Using Social Media Data to Personalize Media Content Recommendations

(71) Applicant: Verizon Patent and Licensing Inc., Arlington, VA (US)

(72) Inventors: Si Ying Diana Hu, Sunnyvale, CA (US); Suri B. Medapati, San Jose, CA (US)

(73) Assignee: Verizon Patent and Licensing Inc.

(21) Appl. No.: 14/486,954

(22) Filed: Sep. 15, 2014

(51) Int. Cl. G06Q 30/02; G06Q 50/00

(52) U.S. Cl. CPC G06Q 30/0269; G06Q 50/01

(57) ABSTRACT

In an exemplary method, a media content recommendation system determines that a media service account of an end user of a media service is linked to a social media account of the end user, accesses social media data from the social media account of the end user of the media service, generates a media content recommendation personalized to the end user of the media service based on the social media data, and provides the media content recommendation to an access device for presentation to the end user of the media service.

### BACKGROUND INFORMATION

A provider of a media service may want to personalize the media service to an end user of the media service in a manner that facilitates a personalized experience with the media service for the end user. For example, a provider of a media service may want to provide personalized media content recommendations to an end user. Conventionally, in a media service, personalized media content recommendations are automatically generated by a recommendations engine based on information about an end user that has been collected through direct interaction of the end user with the media service. For example, through a media service user interface, the media service provider may ask the end user to rank a list of media programs (e.g., movies, television shows, songs, etc.), provide information about the user's media preferences and/or consumption history, and/or provide other information about the user. As another example, the media service provider may glean information about the end user from regular, in-line interactions of the user with the media service, including interactions such as the user accessing and consuming a media program.

The generation of personalized media content recommendations can be less accurate and/or less effective, however, when a conventional recommendations engine attempts to generate media content recommendations for a new user of a media service because, at least initially, the recommendations engine has access to little or no helpful information about the media preferences of the new user. For example, the new user may have had little or no tracked interactions with the media service and/or may not have yet provided information about the user's media preferences to the media service provider. Such a lack of useful information about the media preferences of a new user of a media service has created difficulty for conventional recommendations engines to accurately and/or effectively personalize media content recommendations to the new user.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary configuration in which a media content recommendation system accesses social media data from a social media system and uses the social media data to generate and output media content recommendation data representing a personalized media content recommendation according to principles described herein.

FIG. 2 illustrates the exemplary configuration of FIG. 1 in which the social media system maintains a social media account for an end user of a social media service according to principles described herein.

FIG. 3 illustrates exemplary components of the media content recommendation system of FIG. 1 according to principles described herein.

FIG. 4 illustrates an exemplary generation of media content recommendation data based on social media data according to principles described herein.

FIG. 5 illustrates an exemplary implementation of the system media content recommendation system of FIG. 1 according to principles described herein.

FIG. 6 illustrates an exemplary configuration in which a media content recommendation system accesses social media data from a social media system and media service interaction data from a media service system and uses the accessed data to generate media content recommendation data representing a personalized media content recommendation according to principles described herein.

FIGS. 7-8 illustrate exemplary media content recommendation personalization methods according to principles described herein.

FIG. 9 illustrates an exemplary computing device according to principles described herein.

### DETAILED DESCRIPTION OF PREFERRED EMBODIMENTS

Exemplary systems and methods of using social media data to personalize media content recommendations are described herein. Systems and methods described herein may access social media data from one or more social media systems and use the accessed social media data to generate personalized media content recommendations. In certain examples, systems and methods described herein may use the social media data to generate a media content recommendation that is personalized to an end user of a media service, such as a new user of the media service.

For example, an exemplary system may determine that a media service account of an end user of a media service is linked to a social media account of the end user and access social media data from the social media account of the end user of the media service. The system may then generate a media content recommendation personalized to the end user of the media service based on the social media data and provide the media content recommendation to an access device for presentation to the end user of the media service. Examples of social media data that may be accessed and used to personalize media content recommendations, as well as examples of ways that personalized media content recommendations may be generated based on the social media data, are described herein.

Systems and methods described herein may provide accurate and/or convenient personalization of media content recommendations based at least in part on social media data. The leveraging of social media data associated with an end user of a media service to generate media content recommendations personalized to the user may be beneficial when little or no information about the user has been obtained through interaction of the user with the media service, such as when the user is a new user who has only recently registered with the media service. Accordingly, systems and methods described herein may provide a solution to a “cold start” problem experienced by conventional media content recommendation engines when a new user first registers with a media service. Additional or alternative benefits that may be provided by one or more of the exemplary systems and methods described herein will be made apparent herein. Exemplary systems and methods will now be described in reference to the drawings.

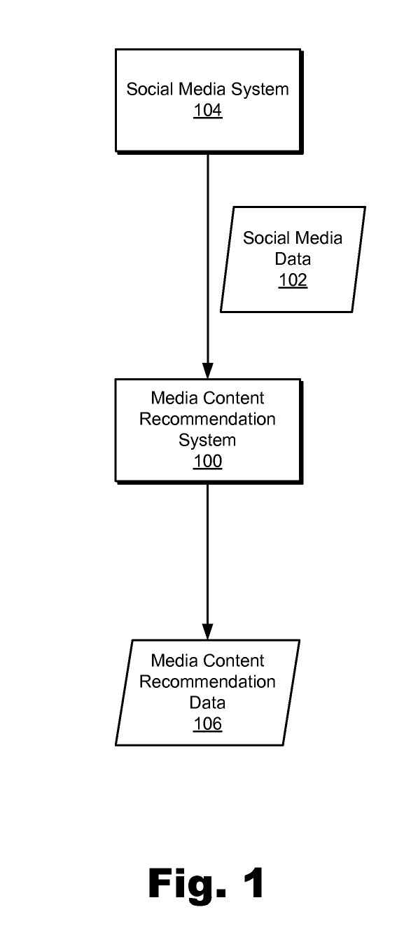

FIG. 1 illustrates an exemplary system configuration in which a media content recommendation system 100 (“system 100”) accesses social media data 102 from a social media system 104 and uses the social media data 102 to generate and provide media content recommendation data 106 representing a personalized media content recommendation.

System 100 may be included in or implemented by one or more computing devices configured to communicate with social media system 104, access social media data 102, and process social media data 102 to generate media content recommendation data 106. In certain examples, system 100 may be associated with (e.g., operated by) a service provider, such as a media service provider (e.g., a media content distribution service provider, a media information service provider, etc.) or a media content recommendation service provider. Exemplary components of and operations performed by system 100 are described further below.

Social media system 104 may be included in or implemented by one or more computing devices configured to provide a social media service to end users of the social media service. The social media service may include any type of social media service, including social networking services, social communications services, content sharing services (e.g., media content sharing services), and any other services that facilitate social interaction among people in virtual communities or and/or networks (e.g., through the creation and exchange of information, ideas, and/or content in virtual communities and/or networks). Examples of social media services include, without limitation, virtual collaborative projects (e.g., WIKIPEDIA), blogs, microblogs (e.g., TWITTER), content sharing communities (e.g., YOUTUBE), social networking sites (e.g., FACEBOOK), and social worlds (e.g., SECOND LIFE).

Social media system 104 may be associated with (e.g., operated by) a social media service provider. In certain examples, the social media service provider may be autonomous of a service provider associated with system 100, and/or social media system 104 may be autonomous (e.g., separate and/or independent) of system 100.

System 100 and social media system 104 may communicate with one another using any suitable data communication technologies. Examples of such communication technologies include, but are not limited to, data transmission media, communications devices, Transmission Control Protocol (“TCP”), Internet Protocol (“IP”), Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Long Term Evolution (“LTE”) technologies, Short Message Service (“SMS”), Multimedia Message Service (“MMS”), radio frequency (“RF”) signaling technologies, wireless communication technologies, Internet communication technologies, Application Program Interface (“API”) technologies, and other suitable data communications technologies.

Social media system 104 may generate and maintain social media data 102, which may include any data associated with a social media service provided by social media system 104. Social media data 102 may include, without limitation, data representing end users of the social media service (e.g., user profiles), interactions of the end users with the social media service (e.g., social media content postings), interactions of the end users with one another by way of the social media service (e.g., social media messaging), and content provided to, accessed from, and/or shared by way of the social media service.

In certain examples, social media data 102 may include data representing social media accounts of end users of the social media service. For example, social media system 104 may generate and maintain a social media account for an end user of the social media service. The social media account may include or be represented by any suitable data structure(s) and may include data associated with the end user. For instance, the social media account may include, without limitation, a social media service user profile for the end user, security credentials for accessing the social media account (e.g., a username and password for the end user, access device information for one or more access devices associated with the end user, security questions and answers, etc.), demographic information for the end user (e.g., information about the gender, age, geographic location, etc. of the end user), preferences of the end user (e.g., “likes” and/or other indications of user preferences provided by the end user), user-specific settings for the social media service, interactions of the end user with the social media service (e.g., providing, accessing, and/or sharing of social media content by way of the social media service), and content posted by the end user to the social media service (e.g., current and/or historical posts, private and/or public posts, etc.).

In certain examples, social media data 102 may include data representing user interactions with the social media service that are related to media content. As used herein, the term “media content” may refer to any form of media that may be distributed by a media distribution service and consumed by an end user of the service, such as commercially distributed forms of media. Media content may include discrete instances of media, which may be referred to as media programs. The term “media program” may refer to any television program, on-demand media program, pay-per-view media program, broadcast media program (e.g., broadcast television program), multicast media program (e.g., multicast television program), narrowcast media program (e.g., narrowcast video-on-demand program), IPTV media program, video, movie, audio program, radio program, and/or any other media content instance that may be distributed by way of a media distribution service and presented by way of a media content processing device (e.g., a set-top box device, a television device, a computing device, a mobile device, a media player device, etc.) for consumption by a user of the media content processing device.

Interactions with the social media service that are related to media content may include any interactions, by end users of the social media service with the social media service, that have relationships with media content that may be identified by system 100 and/or social media system 104. As an example, an end user of the social media service may provide input to the social media service that explicitly refers to media content, such as by referring to a particular media program and/or to a particular attribute of media content (e.g., a genre, actor, actress, topic, rating, or other attribute of media content). To illustrate one example, the end user may provide input to the social media service to explicitly indicate an opinion of the user about a media program, such as input that explicitly indicates that the user likes or dislikes the media program. An illustrative example is a user selection of a “like” feature of a social media service known as FACEBOOK to indicate that the user prefers the media program. To illustrate another example, the end user may provide input to the social media service to share a media program and/or a social media message about the media program with one or more social contacts of the user. To illustrate another example, the end user may provide input to the social media service to rate a media program. These and/or other explicit references to media content in the social media service may be represented in social media data 102 and may be referred to as “explicit feedback” about media content.

As another example of user interactions with the social media service that are related to media content, an end user of the social media service may provide input to the social media service that implicitly refers to media content, such as by referring to a particular media program and/or to a particular attribute of media content (e.g., a genre, actor, actress, topic, rating, or other attribute of media content). To illustrate one example, the end user may provide input to the social media service that implicitly indicates an opinion of the user about a media program, such as input that implies that the user likes or dislikes the media program. For instance, the end user may provide a social media message to the social media service, and the social media message may include content that implies the user's opinion about the media program, such as textual comments and/or language about the media program. An illustrative example is a “tweet” message uploaded to and distributed via a social media service known as TWITTER and that includes textual content that implies the user's opinion about the media program (e.g., text indicating that the user either “could not stop watching” or “fell asleep while watching” a particular movie).

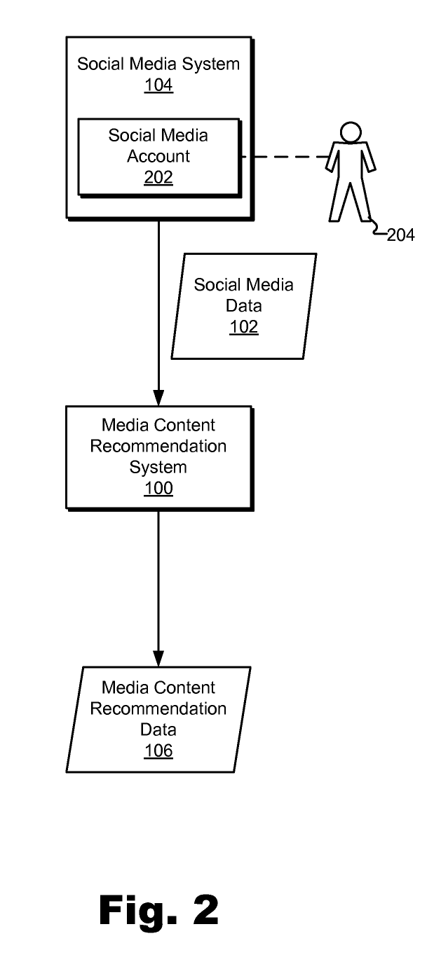

FIG. 2 illustrates an example of the configuration of FIG. 1 in which social media system 104 maintains a social media account 202 for an end user 204 of a social media service. In the example illustrated in FIG. 2, social media data 102 may include data accessed by system 100 from or through social media account 202 of end user 204, and media content recommendation data 106 may represent a media content recommendation personalized to end user 204 based on the social media data 102 accessed from or through social media account 202.

While the exemplary configuration illustrated in FIGS. 1 and 2 shows system 100 accessing social media data 102 from a single social media system 104 and certain examples described herein refer to social media system 104, this is illustrative only. System 100 may access social media data 102 from one or more discrete social media systems (e.g., autonomous social media systems).

Additionally or alternatively, system 100 may access different types of social media data 102 from one or more social media systems, including by accessing any of the exemplary types of social media data 102 described herein. For example, system 100 may access explicit feedback about media content from a first social media service and implicit feedback about media content from a second social media service. To illustrate one example of accessing social media data 102 from different social media systems, system 100 may access a first set of social media data 102 from a first social media system that provides a virtual microblog social media service (e.g., TWITTER) and a second set of social media data 102 from a second social media system that provides a virtual social networking service (e.g., FACEBOOK).

Social media data 102 accessed from multiple social media systems may be associated with a single end user (e.g., end user 204) of the social media services. For example, system 100 may access social media data 102 from multiple social media systems providing social media services used by the single end user.

In certain examples, system 100 may be able to access social media data 102 from social media system 104 because system 100 has received permission to access the social media data 102 from social media system 104. System 100 may receive permission to access social media data 102 in any suitable way.

In certain examples, system 100 may receive permission from end user 204 to access social media account 202 of end user 204. The permission may be received from end user 204 in any suitable way. As an example, system 100 may detect user input indicating that system 100 has been granted permission to access social media account 202 (e.g., a user selection of a graphical user interface object associated with a function of granting access permission to system 100). As another example, system 100 may receive security credentials for accessing social media account 202 from end user 204 (e.g., authentication mechanisms such as access tokens, login credentials, etc. for accessing social media account 202). As another example, system 100 may receive permission to access social media account 202 as part of a linking of social media account 202 to another service (e.g., a linking of a media service account of end user 204 with a media service to social media account 202 of end user 204). These examples are illustrative only, system 100 may receive permission to access social media account 202 from end user 204 in any other suitable way.

In certain examples, system 100 may receive permission from social media system 104 and/or a social media service provider associated with social media system 104 to access social media account 202 of end user 204. As an example, an entity that manages social media system 104 and an entity that manages system 100 may agree that social media system 104 will share social media data 102 with system 100. In view of the agreement, the entity that manages social media system 104 may provide the entity that manages system 100 with security credentials for accessing social media data 102 from social media system 104. System 100 may receive the security credentials, and thereby receive permission to access social media account 202 of end user 204 (and/or other social media accounts of other end users of the social media service).

In certain examples, social media system 104 may provide open access to certain social media data 102. In such examples, system 100 may receive permission, through the open access, to access certain social media data 102, such as public social media posts. Additionally or alternatively, system 100 may receive permission, in any of the ways described herein, to access protected social media data 102 that is not accessible through open access.

System 100 may access social media data 102 from social media system 104 in any suitable way, including by accessing data associated with social media account 202 of end user 204 of the social media service provided by social media system 104. System 100 may send and receive any communications suitable for accessing social media data 102, including any form of data communications suitable for requesting and receiving social media data 102 from social media system 104.

In certain examples, system 100 may access specific social media data 102 from social media account 202. For example, system 100 may access specific instances of data and/or types of data, such as any of the types of social media data 102 described herein. To illustrate, system 100 may be configured to access social media data 102 representing explicit and/or implicit feedback about media content in general or about specific instances of media content (e.g., media programs included in a list of media programs). To illustrate a specific example, system 100 may access social media data 102 representing end-user-provided “likes” and/or “dislikes” of media programs in a social media service such as FACEBOOK. To illustrate another specific example, system 100 may access social media data 102 representing end-user-provided posts about media content, such as public “tweets” in TWITTER. Additionally or alternatively to accessing explicit and/or implicit feedback about media content, system 100 may be configured to access social media data 102 in the form of social media service user profile data for end user 204 from social media account 202.

System 100 may generate media content recommendation data 106 based on the accessed social media data 102. The media content recommendation data 106 may represent one or more media content recommendations personalized to end user 204. Hence, system 100 may generate a media content recommendation personalized to end user 204 based on the accessed social media data 102. System 100 may generate the personalized media content recommendation based on social media data 102 in any suitable way, examples of which are described herein.

System 100 may provide the personalized media content recommendation to end user 204, such as by providing data representative of the personalized media content recommendation to an access device associated with end user 204 for processing and presentation of the personalized media content recommendation to end user 204 by the access device. System 100 may provide the personalized media content recommendation to the access device in any suitable way and using any suitable communication technologies, including any of those mentioned herein.

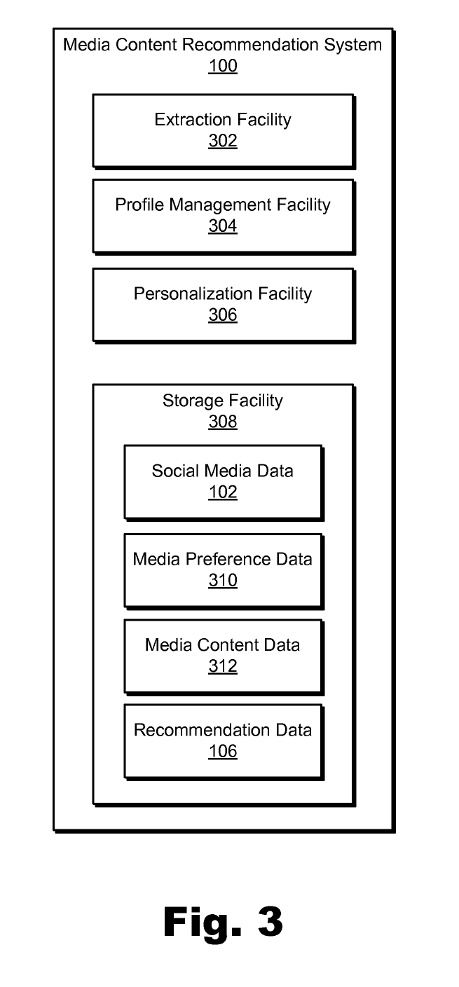

FIG. 3 illustrates exemplary components of system 100. As shown, system 100 may include, without limitation, an extraction facility 302, a profile management facility 304 (“profile facility 304”), a personalization facility 306, and a storage facility 308 selectively and communicatively coupled to one another. Any suitable communication technologies may be employed to facilitate communications between facilities 302-308.

Although facilities 302-308 are shown to be separate facilities in FIG. 3, facilities 302-308 may be combined into a single facility or split into additional facilities as may serve a particular implementation. Additionally or alternatively, storage facility 308 may be omitted from and external to system 100 in certain alternative implementations. Facilities 302-308 of system 100 may include or be otherwise implemented by one or more physical computing devices configured to perform one or more of the operations described herein.

As mentioned, system 100 may access and process social media data to generate and provide a personalized media content recommendation based on the social media data. In certain implementations, the generating of the personalized media content recommendation may be performed by extraction facility 302, profile facility 304, and personalization facility 306. Examples of such operations will now be described.

Extraction facility 302 may extract media preferences of a user from social media data. For example, extraction facility 302 may identify and access, from the social media data, explicit and/or implicit user feedback about media content. From the feedback about media content, extraction facility 302 may extract one or more media preferences of the user. Examples of extracted media preferences and how extraction facility 302 may extract such media preferences from social media data will now be described in reference to social media data 102 accessed from social media account 202 of end user 204.

In certain examples, extraction facility 302 may extract media preferences of end user 204 from explicit feedback about media content provided by end user 204 to social media system 104. For instance, extraction facility 302 may extract media preferences of end user 204 from “likes” of media content provided by end user 204, sharing of media content by end user 204, and/or rating of media content by end user 204 within the social media service provided by social media system 104.

To illustrate, social media data 102 may indicate that end user 204 has explicitly “liked” three particular media programs within the social media service provided by social media system 104. Extraction facility 302 may extract, from the “likes” of the three particular media programs by end user 204, one or more media preferences of end user 204. As an example, extraction facility 302 may determine that end user 204 prefers the three particular media programs. Such media preferences may be referred to as “media program preferences.” As another example, extraction facility 302 may determine, based on the “likes” of the three particular media programs by end user 204, that end user 204 prefers media content having one or more particular attributes. For instance, all three of the particular media programs may be “action” genre media programs, and extraction facility 302 may determine that end user 204 prefers media content in the “action” genre.

A particular media content genre is illustrative of one media content attribute for which end user 204 may have a preference. Extraction facility 302 may similarly determine, based on the “likes” of the three particular media programs by end user 204, that end user 204 prefers media content having any other media content attribute, such as a particular media content category, sub-genre (e.g., mini-genre and/or micro-genre), actor, actress, plot, storyline, director, producer, production studio, rating (e.g., a Motion Picture Association of America (“MPAA”) rating, an end-user rating, etc.), release date (e.g., range of release dates), running time (e.g., range of running times), resolution (e.g., high definition or standard definition), media format (e.g., DVD, BLU-RAY disc, HD, SD, aspect ratio, etc.), or any other attribute of media content. Such media preferences may be referred to as “media attribute preferences.”

In certain examples, a media attribute preference may be represented as a value of a media metadata category. For example, “genre” may be a metadata category, and “action” may be a value of the “genre” metadata category.

In certain examples, extraction facility 302 may extract media preferences of end user 204 from implicit feedback about media content provided by end user 204 to social media system 104. For instance, extraction facility 302 may extract media preferences of end user 204 from a social media message provided by end user 204 within the social media service provided by social media system 104.

To illustrate, social media data 102 may include data representative of a social media message, such as a “tweet,” that contains content (e.g., text, hashtags, handles, etc.) that implies an opinion of end user 204 about media content. Extraction facility 302 may analyze the message content, using any suitable text, language, and/or sentiment analysis technologies, and extract one or more media preferences of end user 204 based on the analysis. As an example, the social media message may be a post in which the user states that a particular media program was “so good.” Extraction facility 302 may analyze the content of the post in any suitable way and using any suitable technologies, such as by performing a natural language analysis, and determine from the analysis that the content of the post implies that end user 204 prefers the particular media program. In this or a similar manner, extraction facility 302 may determine a media program preference of end user 204. Extraction facility 302 may additionally or alternatively determine, based on the determination that end user 204 prefers the particular media program, that end user 204 prefers media content having one or more particular attributes. For instance, the particular media program may be a “sci-fi” genre media programs, and extraction facility 302 may determine that end user 204 prefers media content in the “sci-fi” genre. In this or a similar manner, extraction facility 302 may determine a media attribute preference of end user 204.

Additionally or alternatively to extraction facility 302 determining, based on a determination that end user 204 prefers a particular media program, that end user 204 prefers media content having a media content attribute, extraction facility 302 may determine, directly from the content of a social media message (e.g., a social media post), that end user 204 prefers media content having a media content attribute. For example, a social media post may include content indicating that end user 204 prefers a particular actor or other attribute of media content. Extraction facility 302 may be configured to analyze the content of the social media post and determine that the content indicates that end user 204 prefers the particular actor or other attribute of media content.

In certain examples, extraction facility 302 may extract media preferences of end user 204 from a social media user profile for end user 204 maintained by social media system 104. For instance, extraction facility 302 may extract media preferences of end user 204 from a user profile included in social media account 202 of end user 204.

To illustrate, social media data 102 may include data representative of a social media user profile for end user 204 that contains information about end user 204. Extraction facility 302 may analyze the information in the profile and extract one or more media preferences of end user 204 based on the analysis. As an example, the profile may indicate the gender and age of end user 204. From this information, extraction facility 302 may determine that end user 204 probably prefers media content having certain attributes. For instance, if end user 204 is male and twenty years old, extraction facility 302 may determine that end user 204 probably prefers media content in the “action” genre.

In certain examples, extraction facility 302 may aggregate social media data 102 and extract media preferences of end user 204 based on the aggregation of the social media data 102. An aggregation of social media data 102 may be performed by extraction facility 302 in any suitable way and may form any suitable aggregation of social media data 102. For example, an aggregation may include a set of aggregated explicit feedback about media content, a set of aggregated implicit feedback about media content, a set of aggregated information from a social user profile, a set of aggregated social media data 102 of different types (e.g., an aggregate set of explicit feedback, implicit feedback, and/or profile information), and/or a set of aggregated social media data 102 accessed from different social media systems (e.g., an aggregate set of social media data from a virtual microblog social media service and a virtual social networking service).

Extraction facility 302 may extract media preferences from an aggregation of social media data 102 in any suitable way, including any of those described herein. By extracting media preferences of end user 204 based on an aggregation of social media data 102, extraction facility 302 may be able to determine and extract certain media preferences that would be otherwise unidentifiable without the aggregation. For example, extraction facility 302 may be able to extract comparative or weighted media preferences based on the aggregation. To illustrate one example, an aggregation of social media data 102 may indicate that end user 204 prefers ten particular media programs, three of which are in the “action” genre of media content and five of which are in the “sci-fi” genre of media content. Based on this data, extraction facility 302 may extract weighted media preferences in the form of preference ratios, such as a five-out-of-ten preference for “sci-fi” genre media programs and a three-out-of-ten preference for “action” genre media programs.

To represent a weighted media preference, extraction facility 302 may apply a weight to a media preference. The weight may be applied in any way suitable to quantify a strength of the media preference (e.g., an extent to which end user 204 prefers a media program and/or attribute). For example, extraction facility 302 may assign a preference score to the media preference to quantify the strength of the media preference. In the example described above, for instance, extraction facility 302 may assign a preference score of “5” to the “sci-fi” genre and a preference score of “3” to the “action” genre to represent the relative strength of these media attribute preferences of end user 204.

To illustrate another example of application of a weight to a media preference, extraction facility 302 may apply a weight to a media program preference to indicate a strength of the media program preference. For instance, extraction facility 302 may determine, from social media data 102, that end user 204 explicitly and/or implicitly provided positive sentiment feedback about a particular media program in three discrete instances (e.g., at different times, in different ways, or in any other discrete instances). Extraction facility 302 may apply a weight to a preference for the media program to quantify the preference (e.g., to reflect the number of instances of positive sentiment feedback). For example, extraction facility 302 may apply a count to the media program preference for each discrete instance, such as by assigning a value of “three” to the media program preference.

As another example, extraction facility 302 may determine, from social media data 102, that end user 204 explicitly and/or implicitly provided relatively strong positive sentiment feedback about a particular media program (e.g., a social media message may contain content indicting that end user 204 “really, really loved” the media program and/or based on a frequency of words relative to a stream of social media content of end user 204). Extraction facility 302 may apply a weight to a preference for the media program to quantify the strength of the sentiment of end user 204 toward the media program. For example, extraction facility 302 may apply more than a single count (e.g., a double count) to the media program preference to reflect the strong positive sentiment feedback.

In certain examples, extraction facility 302 may aggregate determined media preferences of end user 304 and use the aggregated media preferences to determine additional media preferences of end user 204. For example, extraction facility 302 may determine, from social media data 102, one or more media programs preferred by end user 204 and may represent the one or more preferred media programs as an aggregate set of one or more media programs. Extraction facility 302 may then use the aggregate set of one or more media programs to determine one or more media preferences of end user 204, such as one or more media attribute preferences to end user 204. For instance, extraction facility 302 may determine, from an aggregate set of preferred media programs, an attribute shared by at least a subset of the preferred media programs. The shared attribute may be a metadata category value shared by at least some of the preferred media programs.

In certain examples, extraction facility 302 may utilize one or more vector spaces to extract media preferences based on social media data 102 and/or to represent the extracted media preferences. For example, extraction facility 302 may use a media program preference vector space associated with end user 204 to represent extracted media program preferences of end user 204. The vector space may include preference vectors modeled as P<mᵢ,sᵢ>, where mᵢ is an i^{th} media program title with a preference score of sᵢ. In certain implementations, the vector space may include preference vectors for a library of media programs, such as media programs included in a catalogue of media programs (e.g., a catalogue of media programs distributed by a media distribution service) that are available to end user 204.

Extraction facility 302 may determine a preference score for a media program represented in the vector space based on social media data 102 and may populate the vector space with the determined preference score. For example, extraction facility 302 may determine a “0” or a “1” value for a media program based on social media data 102 and populate the preference score in the vector for the media program with the determined value. In certain examples, the starting value of the preference score may be “0” for each media program. If extraction facility 302 determines, based on social media data 102, that end user 204 prefers a media program (i.e., a media program preference for the media program), extraction facility 302 may assign a “1” value to the preference score in the vector for the media program. These values are illustrative only. Other values may be used in other examples. For example, extraction facility 302 may assign a weighted preference score to quantify a preference level of end user 204 for a media program, such as described herein.

In certain examples, extraction facility 204 may use the media program preference vector space for end user 204 to represent an aggregation of media program preferences extracted from social media data 102. For example, the media program preference vector space may represent an aggregate set of media programs that have been determined, by extraction facility 204 and based on social media data 102, to be preferred by end user 204.

In certain examples, extraction facility 302 may use the media program preference vector space associated with end user 204 to extract one or more additional and/or alternative media preferences of end user 204 from social media data 102. To illustrate one example, extraction facility 302 may analyze the media program preference vector space and determine, based on preference scores, that end user 204 prefers ten particular media programs out of a library of one hundred media programs. Based on the analysis, extraction facility 302 may determine one or more preference ratios of end user 204. For example, extraction facility 302 may determine that five out of the ten preferred media programs are of a “sci-fi” genre and that three out of the ten preferred media programs are of an “action” genre. Based on this determination, extraction facility 302 may assign a five-out-of-ten preference ratio to the “sci-fi” genre and a three-out-of-ten preference ratio to the “action” genre for end user 204. As another example, extraction facility 302 may determine and assign a five-out-of-one-hundred preference ratio to the “sci-fi” genre and a three-out-of-one-hundred preference ratio to the “action” genre for end user 204.

Such preference ratios may be used by extraction facility 302 to determine and apply weights to media attribute preferences of end user 204. For example, extraction facility 302 may determine the preference of end user 204 for the “sci-fi” genre to have a first weight that quantifies the determined five-out-of-ten preference ratio of the “sci-fi” genre and the preference of end user 204 for the “action” genre to have a second weight that quantifies the determined three-out-of-ten preference ratio of the “action” genre. In this or a similar manner, the preference for the “sci-fi” genre may be assigned more weight than the preference for the “action” genre. Accordingly, the preference for the “sci-fi” genre may be given more weight than the preference for the “action” genre when system 100 defines a media content recommendation for end user 204.

As mentioned, in certain examples, a determination of media preferences of end user 204 by extraction facility 204 may include extraction facility 302 determining weights for the media preferences of end user 204. The weights may be applied and represented in any form suitable for quantifying relative preference levels of end user 204. For example, the weights may be represented as preference ratios, as values on a numerical scale, and/or as any other quantified preference score.

Extraction facility 302 may determine weights for media preferences in any suitable way. In certain examples, extraction facility 302 may use a regression model to do a regression analysis to determine the weights for media preferences. In certain examples, extraction facility 302 may normalize the weights within a global domain (e.g., within a domain of data associated with end user 204 and/or within a domain of data associated with end users of a service) to mitigate biases. System 100 may use weighted media preferences of end user 204 extracted by extraction facility 302 to define a personalized media content recommendation in a way that accounts for the weights applied to the media preferences, such as by prioritizing stronger preferences of end user 204 over weaker preferences of end user 204 and/or boosting similarities between recommended media content and media content preferred by end user 204.

Media preferences of end user 204 that have been extracted by extraction facility 302 may be represented as data in any way suitable for use by system 100 in defining a media content recommendation that is personalized to end user 204 based on the media preferences of end user 204. In certain examples, profile facility 304 may define a media preference profile associated with end user 204 to represent the extracted media preferences of end user 204. Profile facility 304 may define the media preference profile in any suitable way, including by creating and populating a data structure with data representing the media preference profile and the content of the media preference profile (e.g., with data representing weighted media preferences of end user 204 and/or media programs selected and/or ranked in accordance with the weighted media preferences of end user 204).

In certain examples, the media preference profile for end user 204 may include one or more vector spaces that contain data representing media preferences of end user 204. As an example, the media preference profile may include a vector space for a particular media attribute category, such as a particular metadata category. The vector space may include a set of preference vectors that includes a different vector for each available value of the metadata category. For instance, the vector space may be for a “genre” metadata category and may include vectors for genre values such as “action,” “comedy,” “romance,” “adventure,” “sci-fi,” etc. Each vector may include a preference score for the particular genre represented by the vector. Profile facility 304 may define the preference scores in the vector space based on and/or to represent the media preferences extracted by extraction facility 302 from social media data 102. The preference scores may be in any suitable form, including in any form that may represent weights assigned to media preferences.

The media preference profile may include one or more additional vector spaces for one or more other media attribute categories. A vector space may be used to represent any category of media preferences and/or any level of granularity of media preferences. In certain examples, the media preference profile may represent a hierarchy of media attribute categories that includes levels of granularity from high-level attribute categories (e.g., a genre category) to more granular attribute categories (e.g., a subject matter category). The hierarchy of media attribute categories may be represented in any suitable way in the media preference profile, including within a hierarchy of vector spaces.

In addition or alternative to data (e.g., vectors spaces) representing preferences within media attribute categories, the media preference profile may include data (e.g., one or more vector spaces) representing extracted media program preferences. For example, the media preference profile may be defined by profile facility 304 to include a vector space that represents media program preferences of end user 204. As an example, such a vector space may include vectors representing a set of media programs that have attributes similar to attributes preferred by end user 204. Such vectors may include similarity scores quantifying levels of similarity of the media programs to the media attribute preferences of end user 204. The media programs may be ranked by the similarity scores such that system 100 may select relatively more similar media programs before less similar media programs when defining a media content recommendation personalized to end user 204.

Personalization facility 306 may define a media content recommendation personalized to end user 204 based on the extracted media preferences of end user 204. Personalization facility 306 may do this in any suitable way. For example, personalization facility 306 may access and use data included in a media preference profile defined by profile facility 304 for end user 204 to define a personalized media content recommendation for end user 204.

In certain examples, the definition of a personalized media content recommendation may include personalization facility 306 selecting, from a library of media programs (e.g., a library of media programs available to end user 204 through a media distribution service) and based on the media preference profile for end user 204, one or more media programs that have one or more attributes preferred by end user 204. The selected media programs may be media programs that are not included in the aggregate set of media programs that have been determined, by extraction facility 302 from social media data 102, to be preferred by end user 204. For example, the selected media programs may include a media program that is related to the media programs in the aggregate set of media programs, such as a media program that shares a common attribute with the media programs in the aggregate set of media programs, or a media program that has an attribute that is considered to be a neighboring attribute to an attribute of the media programs in the aggregate set of media programs. A neighboring attribute may be an attribute that is not the same as but is similar to another attribute. For example, a “sci-fi” genre may be a neighboring attribute to an “action” genre because the two genres often overlap in some of their attributes.

In certain examples, personalization facility 306 may select media programs from the library based on the media preference profile for end user 204 and on a predefined media program selection heuristic, which heuristic may specify one or more rules for selecting media programs based on data included in the media preference profile. For example, based on the media preference profile and the heuristic, personalization facility 306 may identify media programs that may be of interest to end user 204 (e.g., media programs that are similar in attributes to media programs and/or media attributes preferred by end user 204), rank the identified media programs based on one or more prioritization rules, and select a certain number of top-ranked media programs for recommendation to end user 204. To illustrate, personalization facility 306 may identify media programs that are of either “sci-fi” or “action” genres, rank the identified media programs by prioritizing the “sci-fi” media programs or the “action” media programs in accordance with how the genres are weighted in the media preference profile (e.g., with “sci-fi” media programs prioritized over “action” media programs in accordance with a certain preference ratio), and select a subset of the identified media programs based on the prioritization.

Personalization facility 306 may then define a media content recommendation to include data representing the selected media program(s). Personalization facility 306 may define the media content recommendation in any way suitable for use by personalization facility 306 to provide the media content recommendation to end user 204. In this or a similar manner, personalization facility 306 may use the weighted media preferences of end user 204, as extracted by extraction facility 302 from social media data 102, to select media programs to recommend to end user 204 such that the media content recommendation is personalized to end user 204.

Storage facility 308 may store any data accessed, used, and/or generated by facilities 302-306. For example, storage facility 308 may store social media data 102 accessed by extraction facility 302, media preference data 310 representing one or more media preferences extracted by extraction facility 302 from social media data 102, media content data 312 representing information about media content (e.g., media content metadata) for use by extraction facility 302 to extract certain media preferences and/or by personalization facility 306 to define a personalized media content recommendation based on the extracted media preferences, and recommendation data 106 representing a personalized media content recommendation defined by personalization facility 306. Media preference data 310 may include and/or be represented in any suitable data structure(s), including in one or more vector spaces and/or profiles, such as described herein. Storage facility 308 may maintain additional or alternative data as may serve a particular implementation.

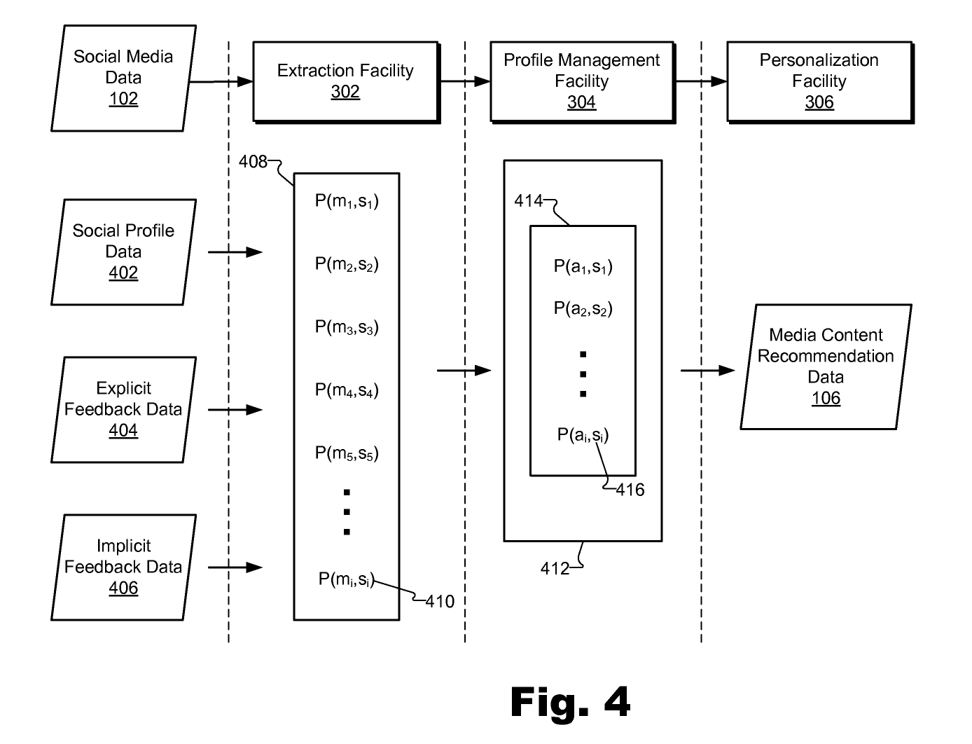

FIG. 4 illustrates an exemplary generation of media content recommendation data 106 based on social media data 102. As shown, extraction facility 302 may access social media data 102, which may include any of the examples of social media data 102 described herein. FIG. 4 illustrates that in certain examples, social media data 102 may include social profile data 402, explicit feedback data 404, and implicit feedback data 406.

Extraction facility 302 may extract media preferences of end user 204 from social media data 102, such as described herein. In the example illustrated in FIG. 4, extraction facility 302 extracts media program preferences from social media data 102 and represents the extracted media program preferences in a media program vector space 408, which includes a set of vectors, each vector in the set including data representing a particular media program and a preference score for the media program. For example, the set of vectors includes a vector 410 that includes data (mᵢ) representing an i^{th} media program and data (sᵢ) representing a preference score for the media program. Extraction facility 302 may also extract media attribute preferences based on social media data 102 and/or data included in vector space 408, such as described herein.

Profile facility 304 may define a media preference profile for end user 204, such as described herein. In the example illustrated in FIG. 4, profile facility 304 defines a media preference profile 412 (“profile 412”) for end user 204. Profile 412 may include one or more vector spaces for one or more media attribute categories (e.g., metadata categories). For example, in FIG. 4, profile 412 includes a vector space 414 that represents a set of media attribute preferences of end user 204 for a particular media attribute category. Vector space 414 may include a set of vectors, each vector in the set including data representing a particular media attribute and a preference score for the media attribute. For example, the set of vectors includes a vector 416 that includes data (aₙ) representing an n^{th} media attribute (e.g., a metadata category value) and data (sₙ) representing a preference score for the media attribute.

Personalization facility 306 may generate media content recommendation data 106 based on social media data 102, such as by defining a media content recommendation personalized to end user 204 based on data included in vector space 408 and/or profile 412, such as described herein. Personalization facility 306 may provide media content recommendation data 106 to end user 204, such as by providing the media content recommendation data 106 to an access device associated with end user 204 for processing by the access device to present a personalized media content recommendation to end user 204.

System 100 may access social media data 102, extract media preferences of end user 204 from the social media data 102, and generate media content recommendation data 106 at different times over a period of time. For example, extraction facility 302 may continue to access updated social media data 102 and to extract media preferences from the social media data 102 over time. Accordingly, extraction facility 302 may update the media preferences based on updated social media data. In certain examples, extraction facility 302 may provide more weight to recent social media data 102 than is provided to older social media data 102 when extracting media preferences. Profile facility 304 may update profiles (e.g., profile 412) maintained by profile facility 304 to reflect changes to media preferences extracted by extraction facility 302 based on updated social media data 102.

In certain examples, system 100 may access social media data 102 for one or more social contacts (e.g., virtual friends) of end user 204 and use the social media data 102 to extract media preferences for end user 204 and/or the social contacts of end user 204. For example, system 100 may use social media data 102 of a social contact of end user 204, either in combination with or independently of social media data 102 of end user 204, to generate a media content recommendation that is personalized to end user 204 based on the social media data 102 of the social contact of end user 204. In certain examples, system 100 may provide end user 204 with an option selectable by end user 204 to direct system 100 whether to use social media data 102 of a social contact of end user 204 to generate a personalized media content recommendation for end user 204. Accordingly, end user 204 may choose whether a media content recommendation that will be provided by system 100 will be influenced by social media activity of a social contact.

System 100 may be implemented as may suit a particular application. In certain examples, for instance, system 100 may be implemented as part of and/or in association with a media service, which may include a media content distribution service, a media information distribution service, a media recommendation service, an on-demand media content service, a television service (e.g., a subscription television service, a “catch-up” television service that provides time-shifted access to television content as a service, a DVR service, a broadcast, multicast, or narrowcast television service, a scheduled television content distribution service, etc.), and/or any other media content related service. Such an implementation may allow personalized media content recommendations generated by system 100 to be provided to an end user of a media service and/or for the media service to be personalized to the end user of the media service in any other suitable way based on social media data of the end user.

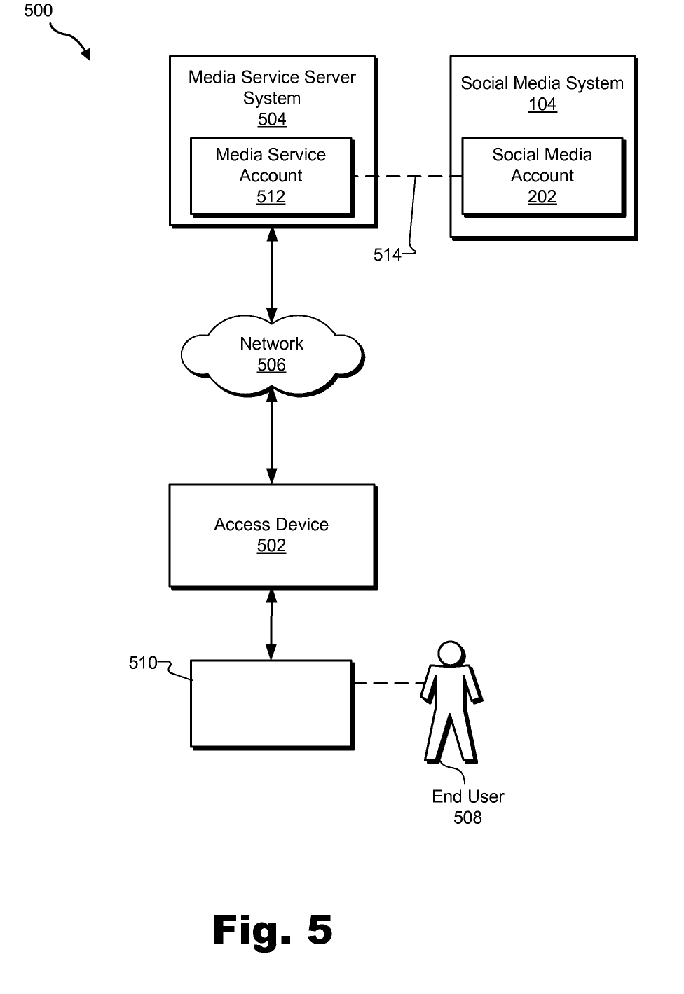

FIG. 5 illustrates an exemplary implementation 500 of system 100. As shown in FIG. 5, implementation 500 may include an access device 502 communicatively coupled to a media service server system 504 (“server system 504”) by way of a network 506. In implementation 500, any of facilities 302-308 of system 100 may be implemented entirely by access device 502, entirely by server system 504, or distributed across access device 502 and server system 504.

Server system 504 and access device 502 may communicate using any communication platforms and technologies suitable for transporting data and/or communication signals, including any of the communication technologies mentioned herein. Network 506 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, live television transmission networks, and any other networks capable of carrying media content, data, and/or communications signals between access device 502 and server system 504. Communications between access device 502 and server system 504 may be transported using any one of the above-listed networks, or any combination or sub-combination of the above-listed networks. Alternatively, access device 502 and server system 504 may communicate in another way such as by one or more direct connections between access device 502 and server system 504.

Server system 504 may include one or more server-side computing devices. Access device 502 may include a media content processing device (e.g., a set-top-box device, DVR device, television, gaming console, personal media player, media server, home media network gateway device, tablet computer, smartphone device, mobile device, etc.) capable of accessing and providing media content and/or media content recommendations for presentation to and experiencing by an end user 508 of the media service.

Server system 504 and/or access device 502 may perform one or more operations to provide a media service to end user 508. Access device 502 may provide a media service user interface 510 through which end user 508 may interact with the media service. Through media service user interface 510, end user 508 may access the media service, such as by accessing one or more features of the media service, media content accessible through the media service, and/or media content recommendations generated by system 100 and personalized to end user 508. In certain examples, media service user interface 510 may include a graphical user interface provided by access device 502 for display on a display screen for use by end user 508. Media program guide user interface 510 may be displayed on any suitable display screen accessible by end user 508, including on a display screen of a display device included in access device 502 or communicatively connected to access device 502.

End user 508 may become an end user of the media service in any suitable way. For example, end user 508 may register with the media service. As part of a user registration process, server system 504 may create a media service account 512 for end user 508. Server system 504 may maintain the media service account 512, which may include data representative of information related to end user 508, such as preference information, demographic information, media consumption history information, media service interaction information, access device 502 information, profile information (e.g., user, device, and/or recommendation profile information) and/or any other information related to end user 508 and/or interactions by end user 508 with the media service. In certain examples, end user 508 may be a new user of the media service who has recently registered with the media service.

Media service account 512 of end user 508 of the media service may be linked to a social media account of end user 508. For example, end user 508 and end user 204 may be the same person, and media service account 512 may be linked to social media account 202 of end user 508 maintained by social media system 104. Such a link is represented by dashed line 514 in FIG. 5.

Media service account 512 may be linked to social media account 202 in any suitable way. For example, end user 508 may provide input (e.g., to server system 504 through media service user interface 510) to direct server system 504 to link media service account 512 to social media account 202. As part of the linking, end user 508 may provide permission to access social media account 202. The permission may be provided in any of the ways described herein, including inherently as part of the linking and/or by providing security credentials for use to access social media account 202.

System 100 may determine that media service account 512 is linked (e.g., has been linked by end user 508) to social media account 202. The determination may be made in any suitable way, such as by detecting user input directing server system 504 to establish the link, receiving a message indicative of the link from access device 502 and/or server system 504, or in any other suitable way.

In response to the detection the media service account 512 is linked to social media account 202, system 100 may perform one or more operations to generate and provide a media content recommendation that is personalized to the new user based on social media data of the new user. For example, system 100 may access social media data from social media account 202 and generate a media content recommendation personalized to end user 508 based on the social media data, in any of the ways described herein. In certain examples, the generation of the media content recommendation may include system 100 extracting, from the social media data, a media preference of end user 508 and defining a media content recommendation personalized to end user 508 based on the media preference of end user 508, such as described herein. System 100 may then provide the personalized media content recommendation to access device 502 for presentation to end user 508.

If end user 508 is a new user of the media service, system 100 may generate and provide the personalized media content recommendation to the new user before system 100 has received and/or used data representative of a user interaction with the media service. As a new user of the media service, the new user may not have provided media preference information to the media service or interacted with the media service in certain ways (e.g., accessed specific media programs, consumed specific media programs, created a “watch,” “wish,” or “favorites” list, etc.) Accordingly, system 100 may have little or no information received through the media service about the media preferences of the new user. However, instead of not providing a media content recommendation or providing a generic, non-personalized media content recommendation to the new user because of the lack of such information, system 100 may still generate and provide the personalized media content recommendation to the new user by accessing and using social media data of the new user to generate and provide the personalized media content recommendation to the new user. This may allow system 100 to provide a personalized media content recommendation to a new user of a media service earlier in time than conventional recommendation systems.

Over time after registration with the media service, end user 508 may interact with the media service. For example, end user 508 may provide input, through media service user interface, to explicitly indicate media preferences of end user 508, add media programs to lists (e.g., a “watch,” “wish,” or “favorites” list), access media programs (e.g., purchased, rented, downloaded, streamed, or otherwise gained access to media programs), consume media programs, rate media programs, share media programs, provide comments about media programs, define settings of the media service, define settings of a media service user profile for end user 508, and/or otherwise interact with the media service.

System 100 may access and use data representative of interactions of end user 508 with the media service (“media service interactions” or “media service interaction data”) to generate and provide a media content recommendation personalized to end user 508. System 100 may generate a personalized media content recommendation based on media service interactions of end user 508 with the media service in any of the ways described herein, including by using media service profile information, explicit feedback about media content, implicit feedback about media content, historical interactions of end user 508 with media content within the media service, and/or any other data representing and/or derived from interactions of end user 508 with the media service to generate a media content recommendation that is personalized to end user 508. Based on such data, system 100 may extract media preferences (e.g., media program preferences and/or media attribute preferences) of end user 508 and generate a personalized media content recommendation based on the media preferences, in any of the ways described herein.

In certain examples, system 100 may access and use both social media data and media service interaction data for end user 508 to generate a personalized media content recommendation for end user 508. For example, initially after a new user registers with the media service, system 100 may primarily, or even exclusively, use social media data to generate a personalized media content recommendation for end user 508. Over time, as the user interacts with the media service and media service interaction data becomes available (e.g., as the user consumes media content through the media service and actual viewership data representing the user's media content consumption accumulates in a viewing history of the user), system 100 may use a combination of social media data and media service interaction data to generate an additional personalized media content recommendation for end user 508. In certain examples, system 100 may apply different weights to social media data and media service interaction data as may suit a particular application. For instance, system 100 may provide more weight to a media service interaction than to feedback about media content within a social media service.

In certain examples, system 100 may generate a personalized media content recommendation for end user 508 based on a combination of social media data and media service interaction data by updating a media preference profile, which may be initially defined by system 100 based primarily or exclusively on social media data for an end user of the media service as described herein, based on one or more interactions of the end user with the media service. After such an update, the media preference profile may represent media preferences of end user 508 that have been extracted from both social media data and media service interaction data for the end user 508.

To illustrate one example, as time progresses, system 100 may model a profile for end user 508 as a historical time evolution by merging social media data and media service interaction data (e.g., media content consumption data) over time using an evolving probability distribution. For example, system 100 may initially populate the probability distribution and/or profile with only the social media data. As time progress, system 100 may adapt the probability distribution and/or profile by blending the social media data with actual viewership data and/or new social media data representing new social media interactions (e.g., new “likes,” new hashtags, etc.).

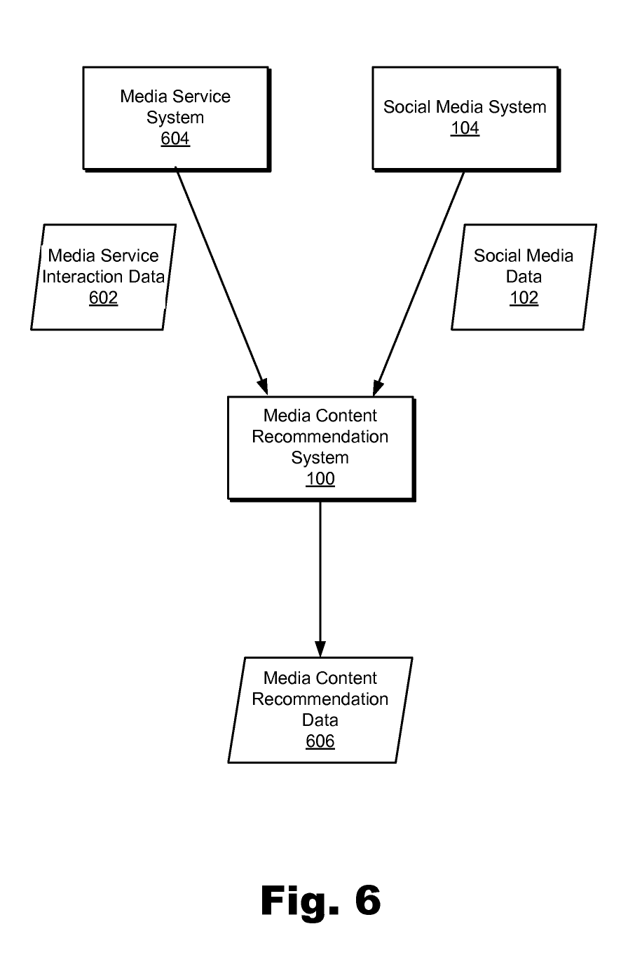

FIG. 6 illustrates an exemplary configuration in which system 100 accesses social media data 102 from social media system 104 and media service interaction data 602 from a media service system 604 and uses the accessed data in combination to generate media content recommendation data 606. Media service system 604 may include one or more computing devices that provide a media service. For example, media service system 604 may include media service server system 504 and/or access device 502. Media service interaction data 602 may represent any interactions of an end user with the media service provided by media service system 604, and social media data 102 may represent any interactions of the end user with the social media service provided by social media system 104. Media content recommendation data 606 may represent a media content recommendation personalized to an end user based on a combination of social media data 102 and media service interaction data 602.

System 100 may provide a personalized media content recommendation to an end user in any suitable context and/or as may suit a particular application. For example, system 100 may provide the personalized media content recommendation for presentation in media service user interface 510, as an ad hoc recommendation not based on any particular context, as a recommendation of media content that is similar to and/or divergent from a particular media program (e.g., a “more like this” context, as a recommended neighboring media program in a “branch out” context, etc.), and/or in any other suitable context in which a media program may be recommended.

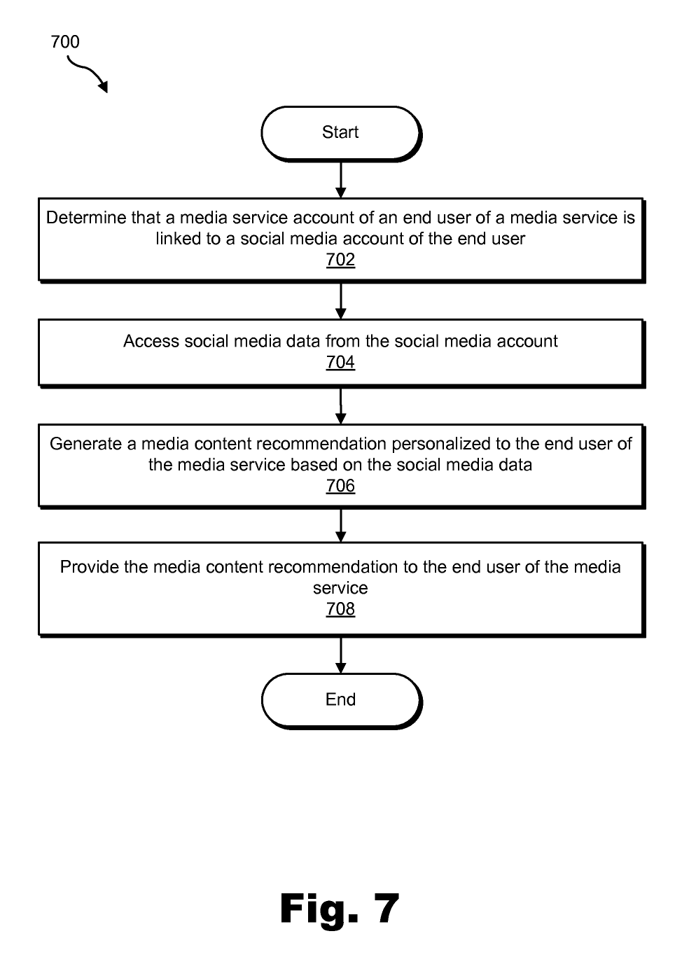

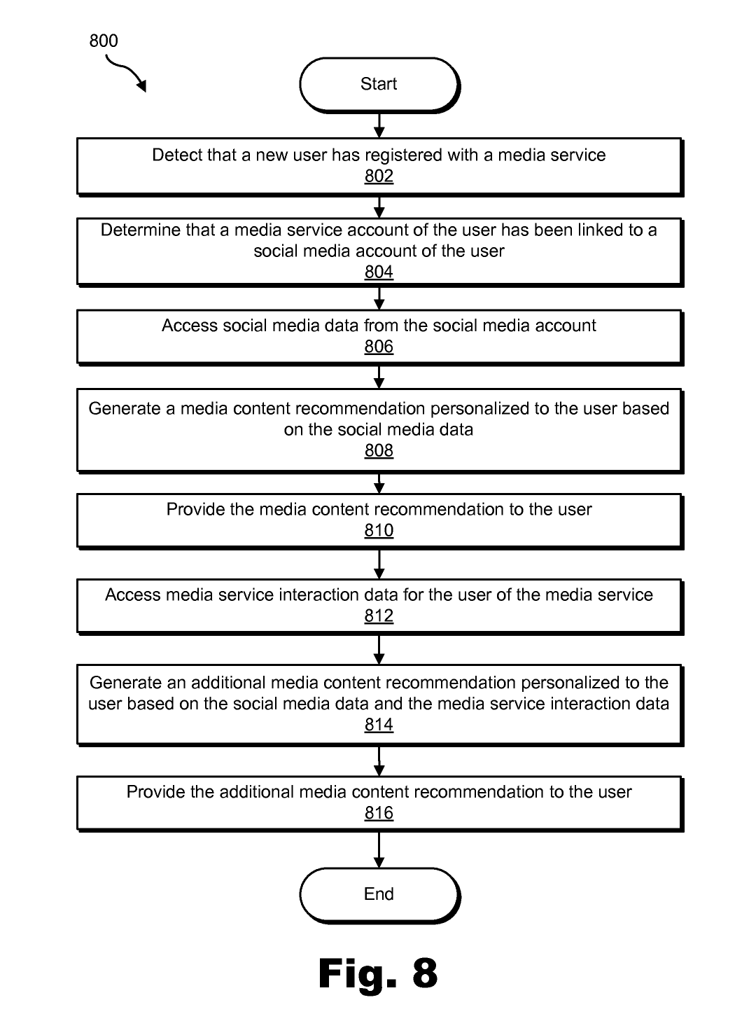

FIGS. 7-8 illustrate exemplary media content recommendation personalization methods 700-800 according to principles described herein. While FIGS. 7-8 illustrate exemplary steps according to certain embodiments, other embodiments may omit, add to, reorder, combine, and/or modify any of the steps shown in FIGS. 7-8. In certain embodiments, one or more of the steps shown in FIGS. 7-8 may be performed by system 100 and/or one or more components or implementations of system 100, such as by a computing device implementing system 100.

In step 702 of method 700, a media content recommendation system determines that a media service account of an end user of a media service is linked to a social media account of the end user, such as described herein.

In step 704, the media content recommendation system accesses social media data from the social media account of the end user of the media service, such as described herein. For example, in response to the determination in step 702 that the media service account of the end user is linked to the social media account of the end user, the media content recommendation system may access social media data from the social media account of the end user, such as described herein.

In step 706, the media content recommendation system generates a media content recommendation personalized to the end user of the media service based on the social media data. Step 706 may be performed in any of the ways described herein.

In step 708, the media content recommendation system provides the media content recommendation to the end user of the media service, such as described herein.

In step 802 of method 800, a media content recommendation system detects that a new user has registered with a media service, such as described herein.

In step 804, the media content recommendation system determines that a media service account of the user of the media service has been linked (e.g., by the user) to a social media account of the user, such as described herein.

In step 806, the media content recommendation system accesses social media data from the social media account of the user of the media service, such as described herein.

In step 808, the media content recommendation system generates a media content recommendation personalized to the user of the media service based on the social media data. Step 808 may be performed in any of the ways described herein.

In step 810, the media content recommendation system provides the media content recommendation to the user of the media service, such as described herein.

In step 812, the media content recommendation system accesses media service interaction data for the user of the media service, such as described herein.

In step 814, the media content recommendation system generates an additional media content recommendation personalized to the user of the media service based on the social media data and the media service interaction data. Step 814 may be performed in any of the ways described herein.

In step 816, the media content recommendation system provides the additional media content recommendation to the user of the media service, such as described herein.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions executable by one or more computing devices. In general, a physical computer processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known non-transitory computer-readable media.

A non-transitory computer-readable medium (also referred to as a processor-readable medium) includes any non-transitory medium that participates in providing data (e.g., instructions) that may be read by a computer (e.g., by a processor of a computer). Such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

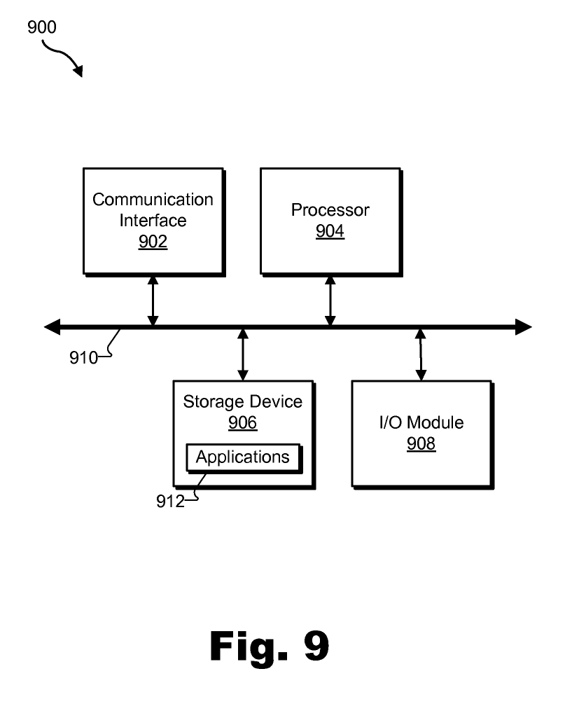

FIG. 9 illustrates an exemplary computing device 900 that may be configured to perform one or more of the processes described herein. As shown in FIG. 9, computing device 900 may include a communication interface 902, a processor 904, a storage device 906, and an input/output (“I/O”) module 908 communicatively connected via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a communications medium interface, a modem, and any other suitable interface. Communication interface 902 may be configured to interface with any suitable communication media, protocols, and formats, including any of those mentioned above.

Processor 904 generally represents any type or form of processing unit capable of processing data or interpreting, executing, and/or directing execution of one or more of the instructions, processes, and/or operations described herein. Processor 904 may direct execution of operations in accordance with one or more applications 912 or other computer-executable instructions such as may be stored in storage device 906 or another computer-readable medium.

Storage device 906 may include one or more data storage media, devices, or configurations and may employ any type, form, and combination of data storage media and/or device. For example, storage device 906 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 906. For example, data representative of one or more executable applications 912 (which may include, but are not limited to, one or more of the software applications configured to direct processor 904 to perform any of the operations described herein may be stored within storage device 906.

I/O module 908 may be configured to receive user input and provide user output and may include any hardware, firmware, software, or combination thereof supportive of input and output capabilities. For example, I/O module 908 may include hardware and/or software for capturing user input, including, but not limited to, a keyboard or keypad, a touch screen component (e.g., touch screen display), a receiver (e.g., an RF or infrared receiver), and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 900. For example, one or more applications 912 residing within storage device 906 may be configured to direct processor 904 to perform one or more processes or functions associated with extraction facility 302, profile facility 304, and/or personalization facility 306. Likewise, storage facility 308 may be implemented by or within storage device 906. In such implementations, system 100 may be referred to as a computer-implemented system 100.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
determining, by a media content recommendation system, that a media service account of an end user of a media service is linked to a social media account of the end user;
accessing, by the media content recommendation system in response to the determining that the media service account of the end user is linked to the social media account of the end user, social media data from the social media account of the end user;
generating, by the media content recommendation system, a media content recommendation personalized to the end user of the media service based on the social media data; and
providing, by the media content recommendation system, the media content recommendation to an access device for presentation to the end user of the media service.

2. The method of claim 1, wherein the generating of the personalized media content recommendation comprises:
determining, from the social media data, a set of one or more media programs preferred by the end user of the media service; and
determining, based on the set of one or more media programs preferred by the end user of the media service, a media attribute preference of the end user of the media service.

3. The method of claim 2, wherein the media attribute preference comprises a preference for an attribute shared by the one or more media programs included in the set of one or more media programs preferred by the end user of the media service.

4. The method of claim 3, wherein the shared attribute comprises a metadata category value shared by the one or more media programs included in the set of one or more media programs preferred by the end user of the media service.

5. The method of claim 2, wherein the generating of the personalized media content recommendation further comprises:
applying a weight to the media attribute preference of the end user of the media service; and
defining the personalized media content recommendation based at least in part on the weight applied to the media attribute preference of the end user of the media service.

6. The method of claim 2, wherein the determining of the set of one or more media programs preferred by the end user of the media service comprises at least one of:
using explicit feedback about the one or more media programs and represented by the social media data to identify the set of one or more media programs; and
using implicit feedback about the one or more media programs and represented by the social media data to identify the set of one or more media programs.

7. The method of claim 1, wherein the generating of the personalized media content recommendation comprises:
determining, from the social media data, a set of media programs preferred by the end user of the media service;
determining, based on the set of media programs preferred by the end user of the media service, an attribute shared by at least a subset of the media programs included in the set of media programs;
applying a weight to the shared attribute; and
selecting, from a library of media programs based on the weight applied to the shared attribute, an additional media program that is not included in the set of media programs preferred by the end user of the media service; and
defining the personalized media content recommendation to represent the additional media program.

8. The method of claim 1, wherein the generating of the media content recommendation comprises:
determining, from the social media data, a set of media programs preferred by the end user of the media service;
defining a media program preference vector space to represent that the end user prefers the set of media programs;
determining, based on data included in the media program preference vector space, a first media attribute preference and a second media attribute preference of the end user of the media service; and
determining, based on data included in the media program preference vector space, a first weight for the first media attribute preference and a second weight for the second media attribute preference.

9. The method of claim 8, wherein the generating of the media content recommendation further comprises defining a media preference profile associated with the end user to represent the first weight for the first media attribute preference and the second weight for the second media attribute preference.

10. The method of claim 9, wherein the generating of the media content recommendation further comprises:
selecting, from a library of media programs based on the media preference profile associated with the end user, an additional media program that is not included in the set of media programs preferred by the end user of the media service; and
defining the personalized media content recommendation to represent the additional media program.

11. The method of claim 1, further comprising:
accessing, by the media content recommendation system, media service interaction data representing one or more interactions of the end user with the media service; and
generating, by the media content recommendation system, an additional media content recommendation personalized to the end user based on a combination of the social media data and the media service interaction data.

12. The method of claim 11, wherein the generating of the additional personalized media content recommendation comprises:
updating a media preference profile associated with the end user based on the one or more interactions of the end user with the media service; and
defining the additional personalized media content recommendation based on the updated media preference profile associated with the end user.

13. The method of claim 1, embodied as computer-executable instructions on at least one non-transitory computer-readable medium.

14. A method comprising:
determining, by a media content recommendation system, that a media service account of a new user of a media distribution service has been linked, by the new user, to a social media account of the new user;
accessing, by the media content recommendation system in response to the determining that the media service account of the new user has been linked to the social media account of the new user, social media data from the social media account of the new user;
generating, by the media content recommendation system, a media content recommendation personalized to the new user of the media distribution service based on the social media data;
providing, by the media content recommendation system, the personalized media content recommendation to an access device for presentation to the new user of the media distribution service;
accessing, by the media content recommendation system, media service interaction data representing one or more interactions of the new user with the media distribution service that occurred subsequent to the providing of the personalized media content recommendation to the access device for presentation to the new user of the media distribution service;
generating, by the media content recommendation system, an additional media content recommendation personalized to the new user of the media distribution service based on a combination of the social media data and the media service interaction data; and
providing, by the media content recommendation system, the additional personalized media content recommendation to the access device for presentation to the new user of the media distribution service.

15. The method of claim 14, wherein the generating of the personalized media content recommendation comprises:
extracting a media preference of the new user from the social media data;
defining a media preference profile for the new user based on the media preference; and
defining the personalized media content recommendation based on the media preference profile.

16. The method of claim 15, wherein the generating of the additional personalized media content recommendation comprises:
extracting an additional media preference of the new user from the media service interaction data;
updating the media preference profile for the new user based on the additional media preference; and
defining the additional personalized media content recommendation based on the updated media preference profile.

17. The method of claim 14, embodied as computer-executable instructions on at least one non-transitory computer-readable medium.

18. A system comprising:
at least one physical computing device that:
determines that a media service account of an end user of a media content distribution service is linked to a social media account of the end user;
accesses, in response to the determination that the media service account of the end user is linked to the social media account of the end user, social media data from the social media account of the end user;
generates a media content recommendation personalized to the end user of the media content distribution service based on the social media data; and
provides the media content recommendation for presentation to the end user of the media content distribution service.

19. The system of claim 18, wherein the at least one physical computing device generates the personalized media content recommendation by:
determining, from the social media data, a set of one or more media programs preferred by the end user of the media content distribution service;
determining, based on the set of one or more media programs preferred by the end user of the media content distribution service, a media attribute preference of the end user of the media content distribution service;
applying a weight to the media attribute preference of the end user of the media content distribution service; and
defining the personalized media content recommendation based at least in part on the weight applied to the media attribute preference of the end user of the media content distribution service.

20. The system of claim 19, wherein the determining of the set of one or more media programs preferred by the end user of the media service comprises at least one of:
using explicit feedback about the one or more media programs and represented by the social media data to identify the set of one or more media programs; and
using implicit feedback about the one or more media programs and represented by the social media data to identify the set of one or more media programs.

21. The system of claim 18, wherein the at least one physical computing device:
accesses media service interaction data representing one or more interactions of the end user with the media service; and
generates an additional media content recommendation personalized to the end user based on a combination of the social media data and the media service interaction data
